(19) United States
(12) Patent Application Publication
(10) Pub. No.: US 2020/0209073 A1
(43) Pub. Date: Jul. 2, 2020

(54) Scanning Switch for Calibration of a Temperature Metering Device and A Calibration System and A Calibration Method thereof

(71) Applicant: Zhenzhen Xu, Taian (CN)

(72) Inventor: Zhenzhen Xu, Taian (CN)

(21) Appl. No.: 16/547,601

(22) Filed: Aug. 22, 2019

(30) Foreign Application Priority Data
Dec. 29, 2018 (CN) 201811647159.7

(51) Int. Cl. G01K 15/00

(52) U.S. Cl. CPC G01K 15/005; G01K 15/002

(57) ABSTRACT

The invention disclosures a scanning switch for calibration of a temperature metering device and a calibration system and a calibration method thereof, comprising main connecting terminals and sub connecting terminals, main connecting terminals are connected to a standard electrical measuring instrument, sub connecting terminals are connected to a calibrated sensor and a standard sensor, main connecting terminals and sub connecting terminals are conductively connected through an electrical measuring switch, the scanning switch further comprises a temperature controller and a temperature control switch which are electrically connected, the temperature control switch is connected to sub connecting terminals, the temperature controller is connected to a constant temperature source by a solid-state relay and connected to standard sensor or calibrated sensor by sub connecting terminals, the temperature control loops of old system are integrated into scanning switch, temperature control sensor is removed, simultaneously the temperature in constant temperature source is real-time controlled.

### BACKGROUND OF THE INVENTION

### Field of the Invention

The invention relates to the technical field of temperature metering device, in particular to a scanning switch for calibration of a temperature metering device and a calibration system thereof.

### Description of the Related Art

In the process of industry production, temperature is one of the most important parameter parameters to be measured and controlled. The temperature metering device used for temperature measurement must be calibrated regularly by calibration system, the calibration system of the temperature metering device generally comprises an electrical measuring instrument, a scanning switch, a constant temperature source and a PC machine, the scanning switch is generally a rotary discs structure, and the electrical measuring instrument is one-to-one connected to a plurality of calibrated sensors by a rotation method.

The scanning switch is an important component in the transmission process of temperature values, and it can control the conduction between the main channel and any sub channels to achieve the purpose of sampling a plurality of signals from a plurality of channels using a standard electrical measuring instrument. In addition to the temperature value transmission method using fixed temperature points, the transmission process of a large number of temperature values are realized by the comparison between the standard and calibration, that is, using a constant temperature source to provide the temperature environment required for the test, putting the standard sensor and the calibrated sensor together into the constant temperature source, and calculating the deviation of the calibrated sensor relative to the standard sensor after the temperature is constant, and further calculating the modification value or the calibration value of the calibrated sensor at that temperature point.

The scanning switches in the prior art are merely provided with a single function of connection switch, the prior working principle of the entire calibration system determines that the constant temperature source must be included in the value transmission system, and as shown in FIG. 2, the constant temperature source is generally provided with an independent temperature control sensor and a temperature controller.

The existing technical problems in the prior art are:

1. A plurality of temperature sensors are provided in the constant temperature source, and the temperature signals output by the standard electrical measuring instrument can be easily received, the additional temperature control loops are used for controlling temperature, which causes waste of resources, thereby the purchase and use cost of the entire system is increased, moreover, it is not easy to operate the layout on site, which has a negative impact on the reliability of the entire system.

2.The nature of the temperature value transmission process is to obtain the modification value or the calibration value of the calibrated sensor at different setup temperature points, which requires that the deviation between the controlled temperature of the constant temperature source and the standard temperature measured by the standard sensor may less than a certain range, for example, the deviation of the temperature control should be less than 2° C. when the standard temperature is 800° C., which may put higher request forward the deviation of sensors in the temperature control loops and the temperature control device. However, the temperature control loops and the electrical measuring instrument are two separate parts, therefore, in order to maintain the normal operation of the whole system, it is necessary to frequently correct the error of the temperature control loops to meet the requirements of the value transmission, which adds extra workload.

In order to solve the above problems, some manufacturers have taken the corresponding transformation measures, such as removing the original temperature control loops (temperature sensor, driver, temperature controller, and etc,) and adopting the temperature data provided by the standard sensor and the standard electrical measuring instrument as the temperature signals, or adding control algorithm in the principal computer and using the principal computer to control the temperature of the constant temperature source. As the method shown in FIG. 3, the main channel of the scanning switch needs to be switched to the standard sensor channel in the temperature rising phase and the constant temperature phase, thereby achieving the purpose of measuring the temperature of the standard sensor. There is no need to use a temperature control sensor and a separate temperature controller, the cost is saved, and the temperature value required for temperature control comes directly from the standard temperature sensor, however, there are still problems with this method, in the later stage of the constant temperature phase, the channel scanning action is required to obtain the measurement result of each channel, in this process, the scanning switch needs to scan the calibrated channels sequentially, and the channel connection time of each calibrated sensor is generally 5-10 s, and the process of patrolling once usually takes more than 1 minute, during this time, the temperature control loops are actually open circuit state, and if there is environmental disturbance, the constant temperature source may have a temperature deviation, simultaneously, the temperature control in the electrical measuring system is still in the state of the last scanning of the standard sensor, which is bound to cause measurement errors in the electrical measuring system.

### SUMMARY OF THE INVENTION

In order to overcome the deficiencies of the prior art, the invention provides a scanning switch for calibration of a temperature metering device and a calibration system thereof, which integrates the temperature control loops of the old system into the scanning switch, removes the temperature control sensor, and simultaneously controls the temperature of the constant temperature source without interruption, and the structure of the invention is simplified, the cost is reduced, and the accuracy of the measurement data of the whole system can be effectively improved.

In order to achieve the above object, the technical scheme adopted by the invention is:

A scanning switch for calibration of a temperature metering device, comprising main connecting terminals and sub connecting terminals, the main connecting terminals are connected to a standard electrical measuring instrument, the sub connecting terminals are connected to a calibrated sensor and a standard transducer, the main connecting terminals and the sub connecting terminals are conductively connected through an electrical measuring switch, the scanning switch further comprises a temperature controller and a temperature control switch, the temperature controller is electrically connected to the temperature control switch, the temperature control switch is connected to the sub connecting terminals, the temperature controller is connected to a constant temperature source by a solid-state relay, and the temperature controller is connected to the standard sensor or the calibrated sensor by the sub connecting terminals.

The invention further comprises a MCU controller, the MCU controller is connected to the electrical measuring switch and the temperature control switch respectively to control the status of the electrical measuring switch and the temperature control switch and to make sure that the electrical measuring switch and the temperature control switch are not connected to one sub terminal block at the same time, which may avoid the occurrence of the parallel connection of the same sub terminal block.

The sub connecting terminals comprise a sub terminal block A connected to the standard sensor, a sub terminal block I connected to calibrated sensor I, and a sub terminal block II connected to calibrated sensor II.

The electrical measuring switch is provided with an optocoupler sensor connected to the MCU controller, the MCU, based upon optical signal, determines the position state of the electrical measuring switch and the connection state between the main connecting terminals and the sub connecting terminals, when the main connecting terminals are connected to the standard sensor through the electrical measuring switch and sub terminal block A, the MCU controller controls the temperature control switch to disconnect from the sub terminal block A, and conducts the connection with other sub connecting terminals other than the sub terminal block A to continue the temperature control of the constant temperature source, for example, the conductive connection with the sub terminal block I or II.

The optocoupler sensor is arranged on a driving mechanism of the electrical measuring switch, that is, on an output shaft of a stepping motor, the output shaft of the motor is fixedly connected to a positioning plate, the positioning plate is uniformly provided with positioning holes, the optocoupler sensor is fixedly arranged near the positioning holes for detecting the rotation angle of the output shaft, thereby obtaining a connection state between the electrical measuring switch corresponding to the rotation angle of the drive output shaft and a certain sub terminal block.

The constant temperature source comprises a constant temperature bath and an electric heating device, the constant temperature groove is heated and controlled by the electric heating device, a standard sensor and a plurality of calibrated sensors are arranged in the constant temperature groove, and the temperature of the constant temperature groove is adjusted and controlled by a temperature controller. The temperature control switch is configured by connecting a plurality of relay switches arranged in parallel to the sub connecting terminals one by one.

Compared to the structure of the conventional calibration system, the temperature control sensor of the temperature controller is replaced by a standard sensor or a calibrated sensor, under normal circumstances, most of the working state of the temperature controller is that the temperature control switch is connected with the standard sensor, and when the electrical measuring switch is switched to connect to the standard sensor, the temperature control switch is disconnected from the standard sensor, then switched to connect to other calibrated sensors, and the temperature control parameter of the temperature controller is slightly adjusted according to the relative physical temperature difference between the calibrated sensor and the standard sensor. After the temperature of the constant temperature source is stabilized, the sensors can be quickly patrolled by the temperature controller to obtain the relative values of the actual measured values of each sensor, for example, the measured temperature of the standard sensor is 800.0° C., the measured temperature of the calibrated sensor is 800.2° C., thereby the relative physical temperature difference between the standard sensor and the calibrated sensor is 0.2° C., when the temperature control switch is switched from the standard sensor to the calibrated sensor I, the original temperature control standard 800.0° C. is automatically adjusted to 800.2° C., and in fact the setup temperature value of the constant temperature source is still maintained at 800.0° C. for real-time monitoring.

The electrical measuring switch is a conventional rotary switch or a multi-channel scanning switch structure of patent No. 201610001918.7, and the rotary discs shaft or the sliding mechanism is driven by the stepping motor to operate and to realize a single connection between sub connecting terminals and main connecting terminals.

Taking the rotary discs type electrical measuring switch as an example, the rotary discs shaft is connected to the stepping motor as a motor output shaft, and the driving motor of the stepping motor is connected and controlled by the MCU controller, the conventional rotary discs type electrical measuring switch comprises a rotary discs comprising contacts, and sub contact chips, the sub contact chips are circumferentially arranged and fixed, and are connected to the sub connecting terminals by wires, the rotary discs is connected to the main connecting terminals, the rotary discs is fixedly provided with contacts, and the contacts are connected to the sub contact chips at corresponding angles when the rotary discs rotates,
the shaft in the invention is fixedly provided with a positioning plate, the positioning plate is uniformly provided with positioning holes, an optocoupler sensor is provided on the moving trajectory of the positioning holes, when the positioning holes pass through the optocoupler sensor, a signal is triggered, and the MCU controller determines the rotation angle of the shaft according to the signal amount of the optocoupler sensor, the different rotation angles represent the connection state between the main connecting terminals and different sub connecting terminals, thereby the connection state between the electrical measuring switch and the sub connecting terminals can be determined by the MCU controller and the optocoupler sensor.

A temperature metering device calibration system with the scanning switch mentioned above, wherein the system comprises a constant temperature source, a scanning switch, an electrical logging device and a PC machine, the scanning switch is provided with main connecting terminals and sub connecting terminals, a standard sensor and a calibrated sensor are arranged in the constant temperature source, the standard sensor and the calibrated sensor are respectively connected to a separate sub terminal block, the main connecting terminals of the scanning switch are connected to the electrical logging device, the electrical logging device is connected to the PC machine, the scanning switch is further provided with a temperature controller, a MCU controller, an electrical measuring switch and a temperature control switch, the electrical measuring switch is used for conducting the main connecting terminals and the sub connecting terminals, the temperature control switch is connected to the sub connecting terminals, the temperature controller is connected to the standard sensor and the calibrated sensors by the temperature control switch, and the MCU controller is connected to the electrical measuring switch, the temperature control switch and the PC machine.

The electrical logging device is a conventional standard electrical measuring instrument used for calibrating the calibrated sensor, which can adopt the Model PR293 Nanovolt & Microhm Thermometer produced by Panran Measurement & Calibration Technology CO., Ltd., or adopt other conventional electrical measuring instruments with equivalent functions.

The PC machine is a principal computer for monitoring an electrical logging device, a temperature controller, an MCU controller, and is provided with a display screen to display the calibrated states and information of the electrical logging device and the temperature controller, the MCU controller is mainly used to allocate the matching state of the temperature control switch and the electrical measuring switch to avoid the two being connected in parallel with the same sub terminal block.

The temperature controller comprises a single-chip microcomputer and an analog-digital converter, the single-chip microcomputer can adopt LPC1768 single-chip microcomputer or other single-chip microcomputers with equivalent function.

The model of the MCU controller is LPC1768.

A temperature metering device calibration method with the scanning switch mentioned above:
wherein a temperature controller is connected to a constant temperature source through a driver to control the temperature, when the constant temperature source reaches the setup constant temperature parameter, 800.0° C. is as a constant temperature in the description hereunder, an electrical logging device is proceeded the calibration process, the electrical logging device is used for patrolling sensors, and the temperature controller is used for monitoring the temperature of the constant temperature source in real time to maintain it at the setup constant temperature parameter:
Step 1: determining the electrical physics difference of the standard sensor and the calibrated sensor, switching the connection state between the temperature control switch and the sub connecting terminals by the temperature controller, patrolling to obtain the measured values of the standard sensor and the calibrated sensor, such as, the measured temperature of the standard sensor is 800.0° C., the calibrated sensor I is 800.2° C., and the calibrated sensor II is 799.7° C., in according with the measured values, the electrical physics difference of the calibrated sensor I relative to the standard sensor is +0.2° C., and the electrical physics difference of the calibrated sensor II relative to the standard sensor is −0.3° C.;
Step 2: the patrolling process of the calibrated sensor is that: the electrical logging device is connected to the main connecting terminals, the main connecting terminals are in sequence conductively connected to the standard sensor, the calibrated sensor I and the calibrated sensor II connected with the sub connecting terminals, when the electrical measuring switch conducting the main connecting terminals and the standard sensor, the temperature control switch may need to open the connection channel, that is, when the electrical measuring switch is connected to the sub terminal block A used for the standard sensor, the temperature control switch of the temperature controller is disconnected from the standard sensor, and conductively connected to the calibrated sensor I, since the “temperature control sensor” for the temperature sensor is replaced herein, the temperature control parameter is adjusted based on the relative electrical physics difference measured before, that is, when the temperature control switch is connected to the calibrated sensor I, the temperature control parameter of the temperature controller is adjusted from 800.0° C. to 800.2° C., and the temperature control parameter of constant temperature source has not change in essence; when the electrical measuring switch is disconnected from the standard sensor, the temperature control switch of the temperature controller is disconnected from the calibrated sensor I, and conductively connected to the standard sensor to continue the temperature control of the constant temperature source.

In the process of the method, the connection states between the electrical logging device and the sub connecting terminals and between the temperature controller and the sub connecting terminals are staggered, which are two independent connecting loops, and the electrical logging device and the temperature controller respectively share the standard sensor and the calibrated sensor connected to the sub connecting terminals.

The driver is a solid-state relay.

Compared to the prior scanning switch for calibration of a temperature metering device and a calibration system thereof, the advantageous effects of the invention are as follows:

1. Compared with the conventional calibration system structure, the costly temperature control sensor and wires are removed, and the temperature controller and the scanning switch are integrated together, thereby the operation layout of the invention is convenient;
2. Compared with the method shown in FIG. 3, the measurement of the standard sensor has been maintained at continuous state in real time, which can effectively ensure the real-time monitoring of the constant temperature source, and can replace the temperature control sensor with the calibrated sensor to maintain the synchronization between the original temperature control sensor and the calibrated sensor, since the calibrated sensor and the standard sensor are all calibrated in a high temperature environment, especially after the temperature is higher than 1000° C., the sensors become consumable, and the temperature controller can effectively identify the calibrated sensor or standard sensor with non-standard temperature display values and beyond the required range;

The invention improves the prior scanning switch in the original temperature values transmission system, and integrates a built-in temperature controller and a temperature control temperature control switch in the scanning switch, the temperature control switch can connect the signal measuring end of the built-in temperature controller to any scanning channel, the temperature control process is implemented by the cooperation between the built-in temperature controller and the temperature control switch, and there is no occurrence of the parallel connection between the temperature controller and the electrical measuring pathways, and the two separate circuits are still two independent parts, the invention has the convenience of standard sensor temperature control, and avoids the occurrence of open circuit of temperature control open circuit and electrical measuring instrument being connected in parallel and interfering the measurement results.

### BRIEF DESCRIPTION OF THE DRAWINGS

FIG. 1 shows the structure of the invention;

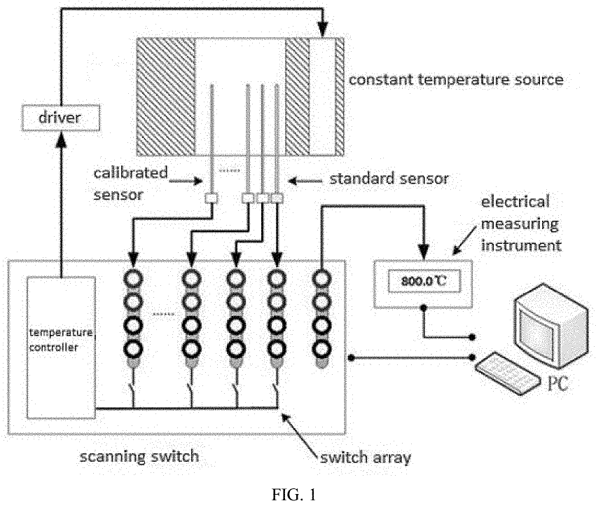

FIG. 2 shows the structure of conventional calibrated system;

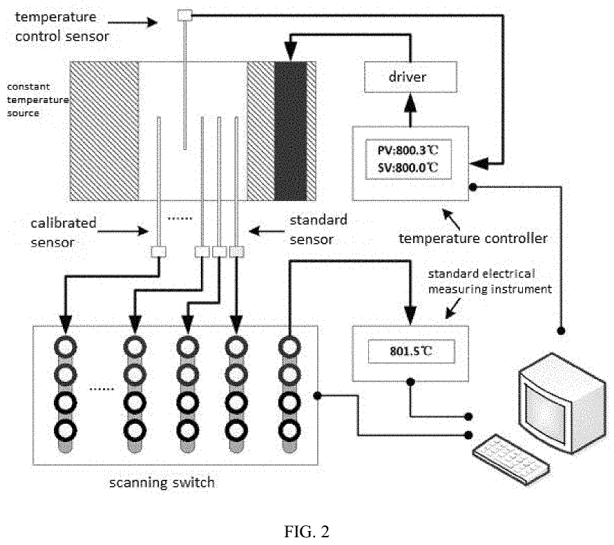

FIG. 3 shows the structure of improved calibrated system;

FIG. 4 is a functional block diagram of the temperature controller in the invention;

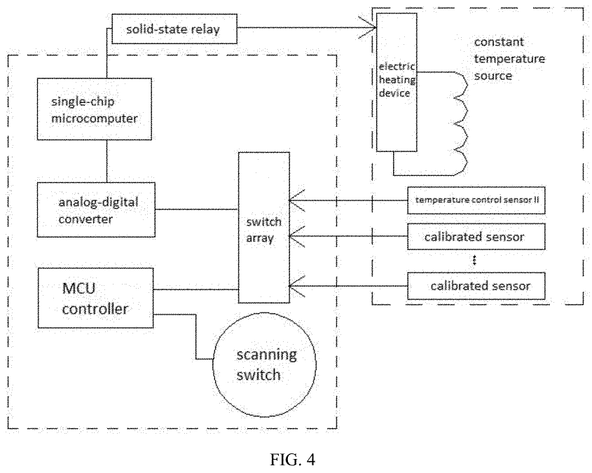

FIG. 5 shows the conventional rotary discs type electrical measuring switch;

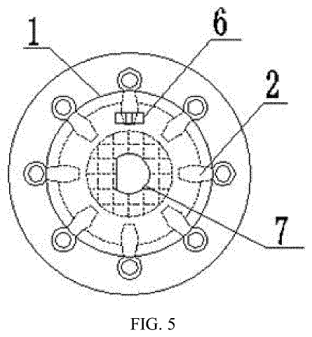

FIG. 6 shows the top view structure of the positioning plate.

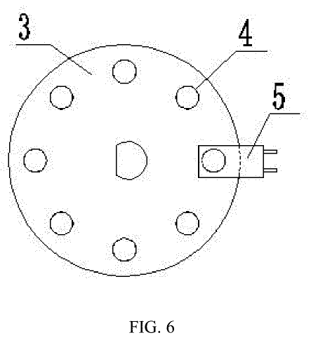

### DETAILED DESCRIPTION OF THE PREFERRED EMBODIMENTS

As shown in the drawings, a scanning switch for calibration of a temperature metering device, comprising main connecting terminals and sub connecting terminals, the main connecting terminals are connected to a standard electrical measuring instrument, the sub connecting terminals are connected to a calibrated sensor and a standard transducer, the main connecting terminals and the sub connecting terminals are conductively connected through an electrical measuring switch, the scanning switch further comprises a temperature controller and a temperature control switch, the temperature controller is electrically connected to the temperature control switch, the temperature control switch is connected to the sub connecting terminals, the temperature controller is connected to a constant temperature source by a solid-state relay, and the temperature controller is connected to the standard sensor or the calibrated sensor by the sub connecting terminals.

The scanning switch further comprises a MCU controller, the MCU controller is connected to the electrical measuring switch and the temperature control switch respectively to control the status of the electrical measuring switch and the temperature control switch and to make sure that the electrical measuring switch and the temperature control switch are not connected to one sub terminal block at the same time, which may avoid the occurrence of the parallel connection of the same sub terminal block.

The sub connecting terminals comprise a sub terminal block A connected to the standard sensor, a sub terminal block I connected to calibrated sensor I, and a sub terminal block II connected to calibrated sensor II.

The electrical measuring switch is provided with an optocoupler sensor connected to the MCU controller, the MCU, based upon optical signal, determines the position state of the electrical measuring switch and the connection state between the main connecting terminals and the sub connecting terminals, when the main connecting terminals are connected to the standard sensor through the electrical measuring switch and sub terminal block A, the MCU controller controls the temperature control switch to disconnect from the sub terminal block A, and conducts the connection with other sub connecting terminals other than the sub terminal block A to continue the temperature control of the constant temperature source, for example, the conductive connection with the sub terminal block I or II.

The constant temperature source comprises a constant temperature groove and a electric heating device, the constant temperature groove is heated and controlled by the electric heating device, a standard sensor and a plurality of calibrated sensors are arranged in the constant temperature groove, and the temperature of the constant temperature groove is adjusted and controlled by a temperature controller. The temperature control switch is configured by connecting a plurality of relay switches arranged in parallel to the sub connecting terminals one by one.

Compared to the structure of the conventional calibration system, the temperature control sensor of the temperature controller is replaced by a standard sensor or a calibrated sensor, under normal circumstances, most of the working state of the temperature controller is that the temperature control switch is connected with the standard sensor, and when the electrical measuring switch is switched to connect to the standard sensor, the temperature control switch is disconnected from the standard sensor, then switched to connect to other calibrated sensors, and the temperature control parameter of the temperature controller is slightly adjusted according to the relative physical temperature difference between the calibrated sensor and the standard sensor. After the temperature of the constant temperature source is stabilized, the sensors can be quickly patrolled by the temperature controller to obtain the relative values of the actual measured values of each sensor, for example, the measured temperature of the standard sensor is 800.0° C., the measured temperature of the calibrated sensor is 800.2° C., thereby the relative physical temperature difference between the standard sensor and the calibrated sensor is 0.2° C., when the temperature control switch is switched from the standard sensor to the calibrated sensor I, the original temperature control standard 800.0° C. is automatically adjusted to 800.2° C., and in fact the setup temperature value of the constant temperature source is still maintained at 800.0° C. for real-time monitoring.

The electrical measuring switch is a conventional rotary switch or a multi-channel scanning switch structure of patent No. 201610001918.7, and the rotary discs shaft or the sliding mechanism is driven by the stepping motor to operate and to realize a single connection between sub connecting terminals and main connecting terminals.

Taking the rotary discs type electrical measuring switch as an example, the rotary discs shaft is connected to the stepping motor as a motor output shaft, and the driving motor of the stepping motor is connected and controlled by the MCU controller, the conventional rotary discs type electrical measuring switch comprises a rotary discs 1 comprising contacts 6, and sub contact chips 2, the sub contact chips 2 are circumferentially arranged and fixed, and are connected to the sub connecting terminals by wires, the rotary discs 1 is connected to the main connecting terminals, the rotary discs 1 is fixedly provided with contacts 6, and the contacts 6 are connected to the sub contact chips 2 at corresponding angles when the rotary discs 1 rotates,
the shaft in the invention is fixedly provided with a positioning plate 3, axle holes 7 are provided in the center of the rotary discs 1 and the positioning plate 3 for the interference connection with to the shaft, the positioning plate 3 is uniformly provided with positioning holes 4, an optocoupler sensor 5 is provided on the moving trajectory of the positioning holes 4, when the positioning holes 4 pass through the optocoupler sensor 5, a signal is triggered, and the MCU controller determines the rotation angle of the shaft according to the signal amount of the optocoupler sensor, the different rotation angles represent the connection state between the main connecting terminals and different sub connecting terminals, thereby the connection state between the electrical measuring switch and the sub connecting terminals can be determined by the MCU controller and the optocoupler sensor.

A temperature metering device calibration system with the scanning switch mentioned above, wherein the system comprises a constant temperature source, a scanning switch, an electrical logging device and a PC machine, the scanning switch is provided with main connecting terminals and sub connecting terminals, a standard sensor and a calibrated sensor are arranged in the constant temperature source, the standard sensor and the calibrated sensor are respectively connected to a separate sub terminal block, the main connecting terminals of the scanning switch are connected to the electrical logging device, the electrical logging device is connected to the PC machine, the scanning switch is further provided with a temperature controller, a MCU controller, an electrical measuring switch and a temperature control switch, the electrical measuring switch is used for conducting the main connecting terminals and the sub connecting terminals, the temperature control switch is connected to the sub connecting terminals, the temperature controller is connected to the standard sensor and the calibrated sensors by the temperature control switch, and the MCU controller is connected to the electrical measuring switch, the temperature control switch and the PC machine.

The electrical logging device is a conventional standard electrical measuring instrument used for calibrating the calibrated sensor, which can adopt the Model PR293 Nanovolt & Microhm Thermometer produced by Panran Measurement & Calibration Technology CO., Ltd., or adopt other conventional electrical measuring instruments with equivalent functions.

The PC machine is a principal computer for monitoring an electrical logging device, a temperature controller, an MCU controller, and is provided with a display screen to display the calibrated states and information of the electrical logging device and the temperature controller, the MCU controller is mainly used to allocate the matching state of the temperature control switch and the electrical measuring switch to avoid the two being connected in parallel with the same sub terminal block.

The temperature controller comprises a single-chip microcomputer and an analog-digital converter, the single-chip microcomputer can adopt LPC1768 single-chip microcomputer or other single-chip microcomputers with equivalent function.

The model of the MCU controller is LPC1768.

The driver is a solid-state relay.

The working process of the calibration system includes two stages of temperature rising and constant temperature calibration of the constant temperature source, the first is temperature rising phase of the constant temperature source, the temperature controller is connected to the sub terminal block I through the temperature control switch, the real-time temperature of the constant temperature source is detected by a standard sensor, the temperature controller is connected to a constant temperature source by a solid-state relay to control temperature, when the constant temperature source reaches the setup constant temperature parameter, 800.0° C. is as a constant temperature in the description hereunder, an electrical logging device is proceeded the constant temperature calibration process;
constant temperature calibration process, Step 1: determining the electrical physics difference of the standard sensor and the calibrated sensor, patrolling the standard sensor and the calibrated sensor by the temperature controller, such as, the measured temperature of the standard sensor is 800.0° C., the calibrated sensor I is 800.2° C., and the calibrated sensor II is 799.7° C., thereby, the electrical physics difference of the calibrated sensor I relative to the standard sensor is +0.2° C., and the electrical physics difference of the calibrated sensor II relative to the standard sensor is −0.3° C.;
Step 2: the patrolling process of the calibrated sensor is that: the main connecting terminals are in sequence conductively connected to the standard sensor, the calibrated sensor I and the calibrated sensor II connected with the sub connecting terminals, when the electrical measuring switch conducting the main connecting terminals and the standard sensor, the temperature control switch may need to open the connection channel, that is, when the electrical measuring switch is connected to the sub terminal block used for the standard sensor, the temperature control switch of the temperature controller is disconnected from the standard sensor, and conductively connected to the calibrated sensor I, since the temperature control sensor for the temperature sensor is replaced herein, the temperature control parameter is adjusted based on the relative electrical physics difference measured before, that is, when the temperature control switch is connected to the calibrated sensor I, the temperature control parameter is adjusted from 800.0° C. to 800.2° C., and the temperature control parameter of constant temperature source has not change in essence; when the electrical measuring switch is disconnected from the standard sensor, the temperature control switch of the temperature controller is disconnected from the calibrated sensor I, and conductively connected to the standard sensor to continue the temperature control of the constant temperature source.

In the process of the method, the connection states between the electrical logging device and the sub connecting terminals, and between the temperature controller and the sub connecting terminals are staggered, which are two independent connecting loops, and the electrical logging device and the temperature controller respectively share the standard sensor and the calibrated sensor connected to the sub connecting terminals.

The advantageous effects of the invention are as follows:

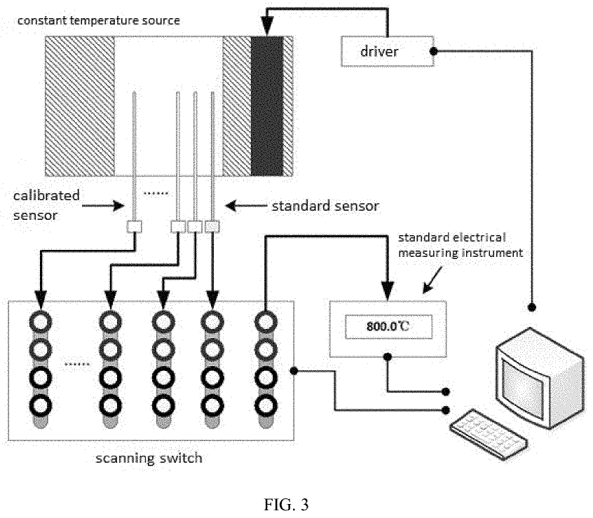

1. Compared with the conventional calibration system structure, the costly temperature control sensor and wires are removed in the invention, and the temperature controller and the scanning switch are integrated together, thereby the operation layout of the invention is convenient;
2. Compared with the method shown in FIG. 3, the measurement of the standard sensor has been maintained at continuous state in real time, which can effectively ensure the real-time monitoring of the constant temperature source, and can replace the temperature control sensor with the calibrated sensor to maintain the synchronization between the original temperature control sensor and the calibrated sensor, since the calibrated sensor and the standard sensor are all calibrated in a high temperature environment, especially after the temperature is higher than 1000° C., the sensors become consumable, and the temperature controller can effectively identify the calibrated sensor or standard sensor with non-standard temperature display values and beyond the required range;
3. The invention has also considered the connection of a separate temperature controller to a standard sensor, which presents a serious drawback: a temperature control sensor can be saved when the temperature signal of the standard sensor is connected in parallel with the temperature controller, and this method seems reasonable, however, connecting any electrical measuring instrument to the original standard electrical measuring circuit in parallel may bring extra effects on the original measurement data, moreover, most temperature controllers may output a certain excitation current to calibrate loop continuity, which may cause greater measurement error of standard temperature electrical measurement;
4. The invention improves the prior scanning switch in the original temperature values transmission system, and integrates a built-in temperature controller and a temperature control temperature control switch in the scanning switch, the temperature control switch can connect the signal measuring end of the built-in temperature controller to any scanning channel, the temperature control process is implemented by the cooperation between the built-in temperature controller and the temperature control switch, and there is no occurrence of the parallel connection between the temperature controller and the electrical measuring pathways, and the two separate circuits are still two independent parts, the invention has the convenience of standard sensor temperature control, and avoids the occurrence of open circuit of temperature control open circuit and electrical measuring instrument being connected in parallel and interfering the measurement results.

The above description is merely a preferred embodiment of the invention, and it should be noted that several improvements without departing from the principles of the invention can be made by those skilled in the art, and these improvements should also be considered as protection of the invention without any creative effort.

1. A scanning switch for calibration of a temperature metering device, comprising main connecting terminals and sub connecting terminals, the main connecting terminals are connected to a standard electrical measuring instrument, the sub connecting terminals are connected to a calibrated sensor and a standard transducer, the main connecting terminals and the sub connecting terminals are conductively connected through an electrical measuring switch, the scanning switch further comprises a temperature controller and a temperature control switch, the temperature controller is electrically connected to the temperature control switch, the temperature control switch is connected to the sub connecting terminals, the temperature controller is connected to a constant temperature source by a solid-state relay, and the temperature controller is connected to the standard sensor or the calibrated sensor by the sub connecting terminals.

2. The scanning switch for calibration of a temperature metering device of claim 1, further comprising a MCU controller, the MCU controller is connected to the electrical measuring switch and the temperature control switch respectively to control the status of the electrical measuring switch and the temperature control switch and to make sure that the electrical measuring switch and the temperature control switch are not connected to one sub terminal block at the same time.

3. The scanning switch for calibration of a temperature metering device of claim 1, wherein the sub connecting terminals comprise a sub terminal block A connected to the standard sensor, a sub terminal block I connected to calibrated sensor I, and a sub terminal block II connected to calibrated sensor II.

4. The scanning switch for calibration of a temperature metering device of claim 3, wherein the electrical measuring switch is provided with an optocoupler sensor connected to the MCU controller, the MCU, based upon optical signal, determines the position state of the electrical measuring switch and the connection state between the main connecting terminals and the sub connecting terminals, when the main connecting terminals are connected to the standard sensor through the electrical measuring switch and sub terminal block A, the MCU controller controls the temperature control switch to disconnect from the sub terminal block A, and conducts the connection with other sub connecting terminals other than the sub terminal block A to continue the temperature control of the constant temperature source, for example, the conductive connection with the sub terminal block I or II.

5. The scanning switch for calibration of a temperature metering device of claim 1, wherein the temperature controller comprises a single-chip microcomputer and an analog-digital converter, the single-chip microcomputer can adopt LPC1768 single-chip microcomputer or other single-chip microcomputers with equivalent function.

6. A temperature metering device calibration system with scanning switch, wherein the system comprises a constant temperature source, a scanning switch, an electrical measuring instrument and a PC machine, the scanning switch is provided with main connecting terminals and sub connecting terminals, a standard sensor and a calibrated sensor are arranged in the constant temperature source, the standard sensor and the calibrated sensor are respectively connected to a separate sub terminal block, the main connecting terminals of the scanning switch are connected to the electrical logging device, the electrical logging device is connected to the PC machine, the scanning switch is further provided with a temperature controller, a MCU controller, an electrical measuring switch and a temperature control switch, the electrical measuring switch is used for conducting the main connecting terminals and the sub connecting terminals, the temperature control switch is connected to the sub connecting terminals, the temperature controller is connected to the standard sensor and the calibrated sensors by the temperature control switch, and the MCU controller is connected to the electrical measuring switch, the temperature control switch and the PC machine.

7. A temperature metering device calibration method for scanning switch, wherein a temperature controller is connected to a constant temperature source through a driver to control the temperature, when the constant temperature source reaches the setup constant temperature parameter, 800.0° C. is as a constant temperature in the description hereunder, an electrical logging device is proceeded the calibration process, the electrical logging device is used for patrolling sensors, and the temperature controller is used for monitoring the temperature of the constant temperature source in real time to maintain it at the setup constant temperature parameter:
Step 1: determining the electrical physics difference of the standard sensor and the calibrated sensor, switching the connection state between the temperature control switch and the sub connecting terminals by the temperature controller, inspecting to obtain the measured values of the standard sensor and the calibrated sensor, such as, the measured temperature of the standard sensor is 800.0° C., the calibrated sensor I is 800.2° C., and the calibrated sensor II is 799.7° C., in according with the measured values, the electrical physics difference of the calibrated sensor I relative to the standard sensor is +0.2° C., and the electrical physics difference of the calibrated sensor II relative to the standard sensor is −0.3° C.;
Step 2: the patrolling process of the calibrated sensor is that: the electrical logging device is connected to the main connecting terminals, the main connecting terminals are in sequence conductively connected to the standard sensor, the calibrated sensor I and the calibrated sensor II connected with the sub connecting terminals, when the electrical measuring switch conducting the main connecting terminals and the standard sensor, the temperature control switch may need to open the connection channel, that is, when the electrical measuring switch is connected to the sub terminal block A used for the standard sensor, the temperature control switch of the temperature controller is disconnected from the standard sensor, and conductively connected to the calibrated sensor I, since the “temperature control sensor” for the temperature sensor is replaced herein, the temperature control parameter is adjusted based on the relative electrical physics difference measured before, that is, when the temperature control switch is connected to the calibrated sensor I, the temperature control parameter of the temperature controller is adjusted from 800.0° C. to 800.2° C., and the temperature control parameter of constant temperature source has not change in essence; when the electrical measuring switch is disconnected from the standard sensor, the temperature control switch of the temperature controller is disconnected from the calibrated sensor I, and conductively connected to the standard sensor to continue the temperature control of the constant temperature source.
